(19) United States
(12) Patent Application Publication
(10) Pub. No.: US 2014/0151226 A1
(43) Pub. Date: Jun. 5, 2014

(54) Potentiometric Measuring Chain

(71) Applicant: Scott Instruments GmbH, Mainz (DE)

(72) Inventor: Günter Tauber, Kriftel (DE)

(73) Assignee: Scott Instruments GmbH, Mainz (DE)

(21) Appl. No.: 14/167,765

(22) Filed: Jan. 29, 2014

Related U.S. Application Data
(63) Continuation of application No. 11/716,832, filed on Mar. 12, 2007.

(30) Foreign Application Priority Data
Mar. 15, 2006 (DE) 10 2006 012 799.4

(51) Int. Cl. G01N 27/333

(52) U.S. Cl. CPC G01N 27/333
USPC 204/416

(57) ABSTRACT

An ion-selective potentiometric measuring chain having the I₃⁻/I⁻ redox system as the reference electrolyte is described, in which the components of the reference electrolyte that determine the potential are regenerable. In particular, iodine or I₃⁻/I⁻ solution can be released in a controlled manner from a body situated in the reference electrolyte.

### CROSS REFERENCE TO RELATED APPLICATION

This patent application claims priority under 35 U.S.C. §120 to and is a continuation application of previously filed U.S. patent application Ser. No. 11/716,832, filed Mar. 12, 2007, entitled “Potentiometric Measuring Chain”, the entire disclosure of which is incorporated herein by reference in its entirety.

### BACKGROUND OF THE INVENTION

The invention relates to an ion-selective potentiometric measuring chain of two potentiometric electrodes, especially for determining pH value, which electrodes are combined, where appropriate, to form a one-piece construction.

A measuring chain of that kind consists of a measuring electrode and a reference electrode. Both electrodes may be combined in a single-rod measuring chain.

The measuring electrode has at its end a membrane that is ion-sensitive towards the ionic species to be determined, is filled with a buffered internal electrolyte and contains an outlet conduit consisting of an inert, electrically conductive material, for example gold, platinum, palladium, iridium or alloys with those metals.

The reference electrode has at its end a porous body, the diaphragm, which makes the electrically conductive connection to the measurement medium. The reference electrode is filled with the reference electrolyte based on the known I₃⁻/I⁻ redox system and contains an outlet conduit consisting of an inert, electrically conductive material, for example gold, platinum, palladium, iridium or alloys with those metals. An electrolyte bridge with a (KCl) bridge electrolyte and outer diaphragm may also be disposed between reference electrode and measurement solution. The voltage measured between measuring electrode and reference electrode corresponds to the concentration of the ions to be determined in the measurement solution.

Such measuring chains are known in the technical field under the name Ros0′m electrode and are described, for example, in DE 31 46 066 C2 (=U.S. Pat. No. 4,495,050). Those measuring chains have the advantage that the electrolyte is free of silver ions at the diaphragm towards the measurement solution and, as a result, known interference is avoided. Owing to the low temperature dependency of the reference potential, such measuring chains respond rapidly.

A disadvantage compared with the conventional Ag/AgCl electrode is the shorter lifetime. The reason for this is that the potential-determining components I₃⁻ and I⁻ diffuse through the internal diaphragm into the KCl bridge electrolyte and consequently the potential changes. It is also possible, for example, for oxygen from the air to alter the redox potential. The use of an intermediate bridge electrolyte is necessary in order to minimise interfering voltages at the diaphragm and to suppress the diffusion of interfering components into the measurement solution. The bridge electrolyte may, in the case of commercially obtainable measuring chains, be regenerated by being replaced, but not the reference electrolyte.

It is known from U.S. Pat. No. 6,793,787 B1 to use a reference electrode that contains a relatively large quantity of the reference electrolyte in a container, that container being in contact with the bridge electrolyte by means of a long, helically wound tube with diaphragm at the end. As a result of the long path through the tube, diffusion of the I₃⁻/I⁻ solution out of the reference electrode and diffusion of contaminating ions towards the reference electrode are delayed and the lifetime of the system is increased. Corresponding measuring chains are sold in various forms under the name Ross™ electrode by the Thermo Electron Corporation, Waltham, Mass., USA.

Although the lifetime of the system is distinctly increased by those measures, permanent stabilisation of the system is not possible. Furthermore, the expenditure in terms of production engineering for the manufacture of such a system is relatively high.

### BRIEF SUMMARY OF THE INVENTION

The object of the invention is therefore to find a pH measuring chain having a I₃⁻/I⁻ reference electrode of the Ross™ type that is simple to manufacture and that has a longer

That object is achieved by the measuring chain described and claimed herein. An ion-selective potentiometric measuring chain consisting of a reference electrode, which contains, as the reference element, an inert metal and, as the reference electrolyte, the known I₃⁻/I⁻ redox system and which is connected to the measurement solution via an electrolyte bridge, and a measuring electrode, which has at its end a membrane that is sensitive to the ionic species to be determined and which is filled with an internal buffer into which a second reference element based on inert metal and I₃⁻/I⁻ redox system is introduced, wherein reference electrode and measuring electrode are combined, where appropriate, into a (one-piece) single-rod measuring chain, characterised in that the components of the reference electrolyte that determine the potential are regenerable.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements and instrumentalities shown. In the drawings:

FIG. 1 shows a schematic longitudinal section through a prior-art measuring chain;

FIG. 2 shows a measuring chain according to the invention, in which the reference electrolyte is regenerable from an iodine reservoir;

FIG. 3 shows a schematic longitudinal section through a different embodiment of a measuring chain according to the invention;

FIG. 4 shows a cross-section of the measuring chain of FIG. 3, along the line A-A; and

FIGS. 5a to 5c show in diagram form a comparison of a conventional measuring chain with two embodiments according to the invention.

### DETAILED DESCRIPTION OF THE INVENTION

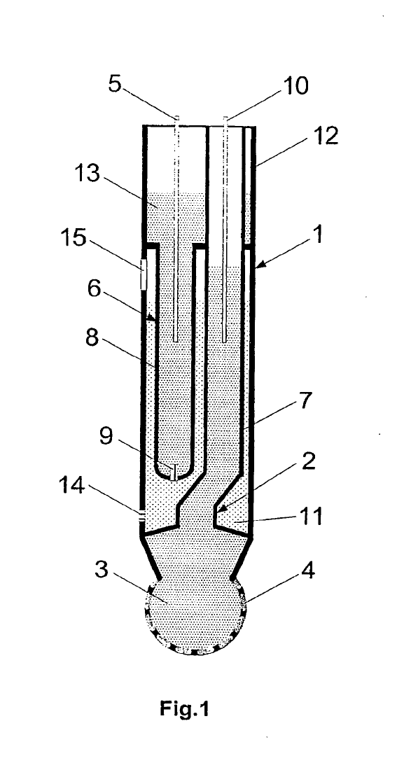

FIG. 1 shows by way of example the general structure of a pH measuring chain with I₃⁻/I⁻ reference electrode. It consists of a measuring half-cell 2, which usually consists of a tubular glass container 7 and is inert towards the internal electrolyte 3. The lower end of the container 7 is terminated by a membrane 4 that is H⁺-ion-selective. Immersed in the internal electrolyte 3 is the outlet conduit 10 by means of which the potential established in the internal electrolyte 3 can be tapped. The internal electrolyte consists of a buffer solution (for example a KH₂PO₄/Na₂HPO₄ solution, each 0.05-molar); in addition, the internal electrolyte also contains the redox pair . The reference electrode is formed by the reference half-cell 6 which consists of a tubular container 8. The container 8 is provided at its end with a diffusion path or diaphragm 9. The container 8 is filled with the reference electrolyte 13, which consists of a solution of the reversible redox pair triodide/iodide required to produce the reference potential.

Immersed in the reference electrolyte is the outlet conduit 5 by means of which the reference potential can be tapped. The outlet conduits 5 and 10 consist of a conductive material that is resistant to the electrolyte, usually platinum. The reference half-cell 6 communicates via the diffusion path 9 with the bridge electrolyte 11 which is situated in a tubular container 12. The container 8 of the reference half-cell is disposed inside the container 12 for the bridge electrolyte. Measuring half-cell 2, reference half-cell 6 and the container 12 for the bridge electrolyte are combined to form a so-called single-rod measuring chain. The bridge electrolyte 11 is in communication with the sample solution to be measured via the diaphragm 14. The container 12 for the bridge electrolyte 11 is provided at its upper end with a closable aperture 15 through which bridge electrolyte 11 may be replenished. The measuring chain may be closed at its upper end in a manner known per se but, for clarity of the drawings, this has not been shown.

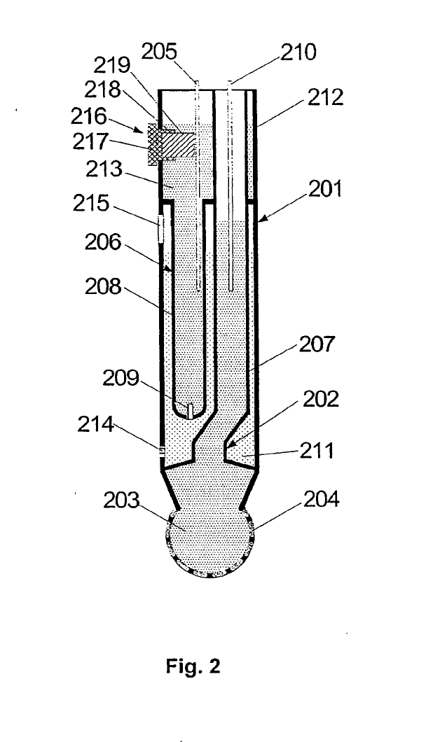

FIG. 2 shows a measuring chain according to the invention with regenerable electrolyte. The measuring chain 201 consists of the measuring half-cell 202 which is tilled with an internal electrolyte 203 and closed at it lower end by the H -ion-selective membrane 204. The potential of the measuring half-cell 202 can be tapped by means of the outlet conduit 210. The internal electrolyte consists of a customary phosphate buffer, such as, for example, that indicated in FIG. 1, but it is also possible for another customary buffer, for example an acetate buffer, to be used. The internal electrolyte 203 further contains the redox pair I₃⁻/I⁻ for establishing a potential. The internal electrolyte may be in the form of an aqueous solution, but may also be in the form of a gel, a sol or the like. The measuring chain 201 further contains the reference half-cell 206 which is in communication via the inner diaphragm 209 with the bridge electrolyte 211 which is situated in a tubular container 212 The bridge electrolyte is in communication with the solution to be measured via the (outer) diaphragm 214. The container 212 for the bridge electrolyte is provided with a closable aperture 215 for replenishing the bridge electrolyte 211.

The reference half-cell 206 contains the reference electrolyte 213 the potential of which can be tapped via the outlet conduit 205. The reference electrolyte 213 consists of an aqueous potassium iodide solution with a content of from 0.05 mol·−1 KI up to a saturated KI solution, especially having a content of approximately 4 mol·1⁻¹ which further contains dissolved iodine (I₂) in a quantity of from 10⁻⁶ mol·1⁻¹ iodine up to a saturated iodine solution, especially approximately 10⁻ mol·1⁻¹ iodine. The iodine is present in the form of the readily soluble I₃⁻ ion. The ratio of the triiodide (I₃⁻) concentration to the iodide (I⁻) concentration determines the outgoing potential (redox potential).

The internal electrolyte 203 has a composition that is the same as or similar to that of the reference electrolyte, and merely contains, in addition, a buffer, for example an acetate buffer or a phosphate buffer.

The compositions both of the internal electrolyte and of the reference electrolyte are sufficiently known to the person skilled in the art and are described in detail, for example, in U.S. Pat. No. 4,495,050,

In order that ions diffusing in from the solution to be measured do not interfere with the potential of the reference electrode, in a manner known per Sc the latter is in communication with the solution to be measured via a bridge electrolyte.

The reference electrode is in electrolytically conductive communication with the bridge electrolyte via the inner diaphragm (209). The diaphragm may consist in known manner of a wick, a porous frit, a porous ceramic material or the like. Through that diaphragm it is also possible, however, for ions, especially I₃⁻ and I⁻ ions, to pass from the reference electrolyte into the bridge electrolyte, with the result that the reference electrolyte becomes depleted on prolonged use. To delay that depletion, endeavours are made to ensure as large as possible a store of iodine and iodide in the reference electrolyte, and the inner diaphragm is made as long as possible and given a small cross-section. In addition, a maximum of 1 mol·l⁻¹, preferably from 0.2 to 0.5 mol·l⁻¹, especially approximately 0.25 mol·l⁻¹, of iodide ions are added to the reference electrolyte, so that the passage of iodide ions from the reference electrolyte into the bridge electrolyte is slowed and, as the result, the lifetime of the reference electrolyte is extended. it may also be advantageous for the bridge electrolyte to contain small quantities of I₃^{- ions, which reduces the diffusion of I}₃⁻ ions out of the reference electrolyte. Up to 10⁻⁶ mol·1⁻¹ of I₃⁻ proved sensible in practice.

Nevertheless, diffusion of the reference electrolyte out of the reference electrode cannot be avoided, no more than can diffusion of interfering ions into the reference electrolyte.

In the measuring chain according to the invention, the reference electrolyte is therefore also regenerable. Regeneration can be done by replacement of the reference electrolyte by providing the reference electrode with a closable aperture through which the spent reference electrolyte can be removed and new reference electrolyte can be supplied, but preferably by providing in the reference electrolyte a reservoir for iodine from which iodine or iodine and iodide is delivered in a specific manner in order to maintain the desired I₃⁻ or I₃⁻/I⁻ concentration. Since the consumption of iodine in the reference electrolyte takes place only very slowly, a slow delivery of small additional quantities of iodine or triiodide/iodide into the reference electrolyte will suffice. For that purpose, an iodine or triiodide/iodide store is placed in the electrolyte, from which the iodine slowly escapes into the electrolyte.

FIG. 2 shows how there is arranged for that purpose in the reference half-cell 206 an aperture 216 which is closed by a plug 217. The plug 217 is provided with clamping jaws 218 holding an iodine reservoir 219, The iodine reservoir 219 may consist of a plastics body in which iodine is dissolved, for example polyvinyl chloride, a fluoropolymer, silicone, an epoxy polymer, a polyurethane, a polyamide, rubber, especially halogenated types of rubber, a polyolefin, for example polyethylene, and other plastics materials, provided that they have a sufficient stability towards the chemical attack of iodine, The plastics reservoir may also consist, however, of a capsule made from one of the mentioned plastics materials and filled with iodine or an iodine solution, through the wall of which iodine is able to diffuse into the reference electrolyte. Furthermore, the material of the capsule may consist of a material that is impermeable to iodine atoms and molecules, for example glass, that is provided only at one site with an aperture or a permeable wall or a permeable closure through which iodine is able to escape into the reference electrolyte. That aperture may also be constructed in the form of a diffusion path, for example a fibre wick or a porous material, for example a glass frit, may be disposed in the aperture. Such a diffusion path is especially suitable for cases where the iodine reservoir contains a I₃⁻/I⁻ solution, since then additional iodide ions also may be delivered to the reference electrolyte. The aperture in the glass capsule may, however, also be closed by a material in which iodine is soluble and through which the iodine molecules are able to diffuse into the reference electrolyte. The quantity of iodine or of an I₃⁻/I⁻ solution diffusing into the reference electrolyte per unit of time can be controlled by the size of the aperture and/or by the choice of material for the diffusion path. The iodine store may furthermore be present in the form of an addition compound or an inclusion compound (e.g. iodine-starch) and be released. therefrom in a controlled manner. The reference half-cell with aperture 216 is especially preferred since, on the one hand, it makes it possible for the reference electrolyte to be changed and, on the other hand, provides the possibility of replacing a depleted iodine store with anew iodine store, for example by changing the body 219. It will be appreciated that the iodine reservoir does not necessarily have to be clamped in the plug 217; it is also possible for the reservoir or a plurality of reservoirs to be placed loosely in the reference half-cell and, for renewal, removed from the half-cell again, if necessary with tweezers or the like.

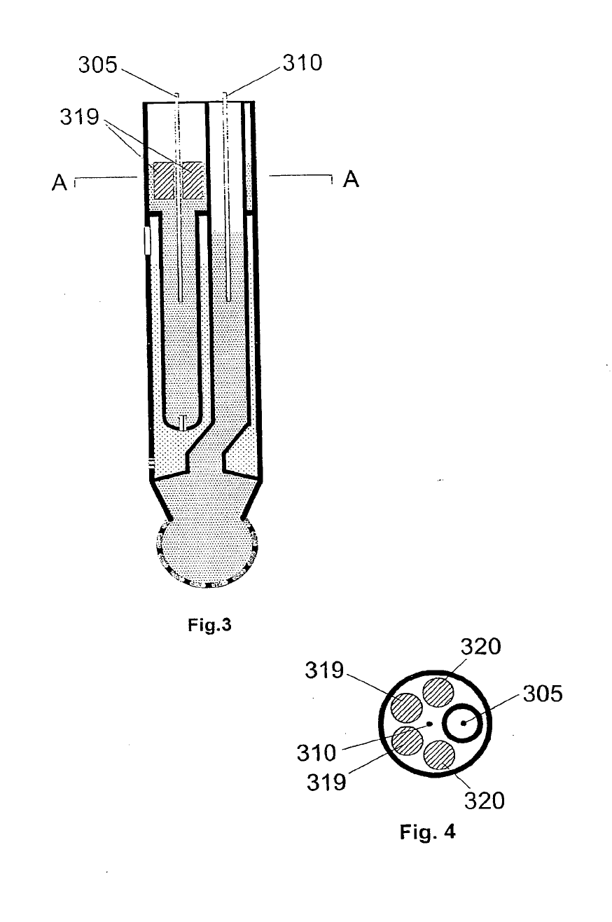

If it is desired to prevent intervention in the reference electrode by the operating personnel or to reduce the amount of maintenance, an embodiment according to FIG. 3 would be suitable. The embodiment is largely identical to the measuring chain according to FIG. 2, but lacks the aperture through which the reference electrolyte would be accessible from the outside. In FIG. 3, essentially only the elements of the drawing that differ from those of FIG. 2 are provided with reference numerals. The iodine reservoir 319, which may consist of the bodies already mentioned, is disposed in the reference half-cell in contact with the reference electrolyte. The reservoirs are especially simple when they consist of iodine-starch in the form of iodised rice grains.

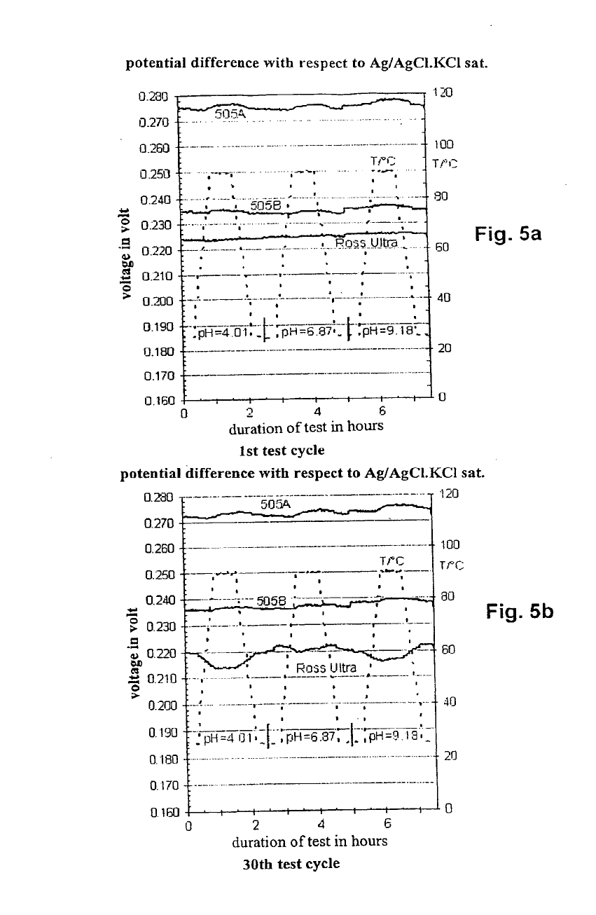

FIG. 4 shows across-section through the measuring chain shown in FIG. 3, along the line A A. It is possible to see the iodine reservoirs 319 disposed at the outlet conduit 305 of the reference half-cell. In addition to the two iodine reservoirs 319, further iodide reservoirs 320 are also disposed in the electrolyte chamber of the reference half-cell.

With the invention it becomes possible for the lifetime of a I₃⁻/I⁻ measuring chain to be distinctly increased.

### EXAMPLE

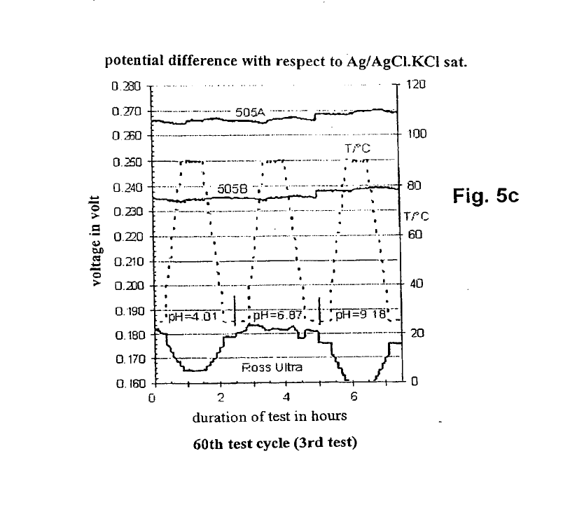

FIGS. 5a. to 5c show extracts from a long-time test with various measuring chains.

The Ross Ultra™ measuring chain is a commercially available I₃⁻/I⁻ measuring chain (model Orion 81-01U Ross Ultra™, made by: Thermo Electron Corporation, Waltham, Mass., USA), and measuring chains 505 A and 505 B are two different forms of a measuring chain according to the invention.

The measuring chains 505 A and 505 B according to the invention were constructed analogously to FIG. 3. The outlet conduits 305 and 310 consisted of platinum. The measuring chains were filled with the following solutions as shown in Tables 1 and 2:

TABLE 1

| | | ratio | | |
|---|---|---|---|---|
| 505 A | [I⁻] in mol/l | [I₃⁻/I⁻]³ | pH | KCl in mol/l |
| reference | 3.8 | 0.009 | | |
| electrolyte | | | | |
| internal | 2.8 | 0.01 | 7.00 | |
| electrolyte | | | | |
| bridge | 0.5 | | | 3.0 |
| electrolyte | | | | |

TABLE 2

| | | ratio | | |
|---|---|---|---|---|
| 505 B | [I⁻] in mol/l | [I₃⁻/I⁻]³ | pH | KCl in mol/l |
| reference | 3.8 | 0.0005 | | |
| electrolyte | | | | |
| Internal | 2.8 | 0.01 | 6.40 | |
| electrolyte | | | | |
| bridge | 0.25 | | | 3.0 |
| electrolyte | | | | |

Measuring chain 505 A contained a single storage body 319. The storage body consisted of a cylindrical glass container with an outside diameter of approximately 2.2 mm and an inside diameter of approximately 1.5 mm and with a length of approximately 30 mm, which contained approximately 0.12 g of elemental iodine. The glass container had an aperture with a diameter of approximately 1.5 mm which was closed by an approximately 3-4 mm long silicone rubber plug. Despite its comparatively high boiling point, iodinc is noticeably volatile even at room temperature. The iodine vapours produced diffuse through the plug material and thus pass into the reference electrolyte. The quantity flow of the iodine delivered from the container can be influenced by the size of the aperture and the material of the plug.

Measuring chain 505 B was identical in construction to measuring chain 505 A with the following differences: the storage body 319 was filled with a saturated I₃⁻/I⁻ solution, the aperture in the glass container was closed by a customary ceramic diaphragm having a customary porosity (15%) and a customary pore size (≦1 μm).

The measuring chains were immersed in standard buffer solutions according to NIST having various pH values as the solution to be measured and were subjected to cyclic thermal loading. As shown in the drawings, in that procedure the measuring chains were kepi in the solution to be measured for approximately 20 minutes at room temperature (25° C.), then heated together with the solution to be measured to 90° C. within approximately 30 minutes, kept at that temperature for one hour, then cooled together with the solution to be measured to room temperature (25° C.) again within approximately 30 minutes, kept at room temperature for approximately 20 minutes, were immersed in the next solution to be measured, also kept at room temperature therein for approximately 20 minutes, heated again as described above and so on. Each test cycle consisted of three heating and cooling phases, the solution to be measured having in the first phase a pH value of 4.01, in the second phase a pH value of 6.87 and in the third phase a pH value of 9.18. As will be seen, the duration of such a test cycle is approximately 7.5 hours,

FIGS. 5a to 5c show the voltage difference obtained with respect to a AglAgCl, KCl saturated reference electrode kept at room temperature, which was in communication with the test solution via an electrolyte bridge, and also show the temperature cycle.

FIG. 5a shows the measured potential of the three measuring chains in the first test cycle, FIG. 5b the potential in the 30th test cycle and FIG. 5c in the 60th test cycle. In the 30th test cycle, relatively large voltage fluctuations are already apparent in the case of the conventional measuring chain and, in the 60th test cycle, the potential in the case of the conventional measuring chain has changed very greatly and, in addition, fluctuates greatly with temperature whereas, in the case of measuring chain 505 A, although the voltage has fallen slightly it is still steady, so that re-calibration would be possible, and the voltage delivered by measuring chain 505 B has remained virtually unchanged.

It will be appreciated by those skilled in the art that changes could be made to the embodiments described above without departing from the broad inventive concept thereof. It is understood, therefore; that this invention is not limited to the particular embodiments disclosed, but it is intended to cover modifications within the spirit and scope of the present invention as defined by the appended claims.

I claim:

1. An ion-selective potentiometric measuring chain comprising:
(i) a reference electrode containing:
a reference element that is an inert metal and
a reference electrolyte that comprises a known redox system, wherein the reference electrode is connected via an electrolyte bridge to a measurement solution containing an ionic species to be determined and I₃⁻ ions of the I₃⁻/I⁻ redox system are regenerable from an iodine store that is in communication with the reference electrode; and
(ii) a measuring electrode having:
at its end a membrane that is sensitive to an ionic species to be determined in the measurement solution, and
an internal buffer into which a second reference element based on inert metal and
I₃⁻/I⁻ redox system is introduced,
wherein reference electrode and measuring electrode are separate or are combined in a single-rod measuring chain.

2. The ion-selective potentiometric measuring chain according to claim 1, characterized in that the iodine store is enclosed in a body, the body comprising a body material from which the iodine is released in a controlled through manner across a membrane, by diffusion or by establishment of an equilibrium across the membrane,

3. The ion-selective potentiometric measuring chain according to claim 2, characterized in that the iodine can be released from an iodine inclusion compound.

4. The ion-selective potentiometric measuring chain according to claim 2, characterized in that the iodine can be released from iodized rice grains.

5. An ion-selective potentiometric measuring chain according to claim 1, characterized in that the iodine is dissolved or enclosed in the body material and is released by diffusion from the body material or through the body material.

6. The ion-selective potentiometric measuring chain according to claim 1, characterized in that the body material consists of a plastics material.

7. The ion-selective potentiometric measuring chain according to claim 1, characterised in that the bridge electrolyte contains iodine and/or I⁻ ions.

8. The ion-selective potentiometric measuring chain according to claim 7, wherein the iodine inclusion compound is selected from an iodine starch and a substance containing an iodine-starch.

9. The ion-selective potentiometric measuring chain according to claim 8, wherein the plastics material is selected from a polyamide, a polyurethane, an epoxy polymer, a silicone polymer, EPDM and glass.
